(19) United States
(12) Patent Application Publication
(10) Pub. No.: US 2011/0069184 A1
(43) Pub. Date: Mar. 24, 2011

(54) PORTABLE REMOTE DEVICE FOR TRANSMITTING PICTURE OF REAL OBJECT AND WRITTEN DATA, AND PRESENTATION METHOD USING THE SAME

(76) Inventor: Youn-Yong Go, Gwangju-si (KR)

(21) Appl. No.: 12/993,619

(22) PCT Filed: Dec. 10, 2008
(86) PCT No.: PCT/KR2008/007301

§ 371 Date: Nov. 19, 2010

(30) Foreign Application Priority Data
May 21, 2008 (KR) 10-2008-0046933

(51) Int. Cl. H04N 5/225

(52) U.S. Cl. 348/207.1; 348/E05.024

(57) ABSTRACT

There is provided a remote data transmission system that includes a hand-held remote device including a camera, a camera button, a wireless communication device for transmitting data obtained by the camera, and a storing device having one or more operating programs; and a computer comprising a display device, wherein the hand-held remote device obtains image data of an object and transmits the image data to the computer when the camera button is pressed, wherein the computer receives data from the hand-held remote device and displays the data on the display device, and wherein the computer displays the image data on the display device upon receipt of the image data.

### TECHNICAL FIELD

The present invention relates to a potable remote device for transmitting a picture of a real object and a presentation method using the same, and more particularly, to a portable remote device having functions of transmitting a picture of a real object and written data and being able to be used while being held in user's hand, and a presentation method using the same.

### BACKGROUND ART

Generally, when lecturing in an enterprise or school, a lecturer executes a presentation program and then displays prepared lecture data on a screen or a computer monitor (hereinafter, called ‘display device’) to show the data in the form of a slide show.

However, in this method, it takes too much time and effort to prepare the lecture data, and also since the lecturer has no choice but to lecture on only the prepared lecture data, there is a limitation in actively meeting various questions or situations occurred on the scene of the lecture.

A visual presenter is used as auxiliary means to solve the problem. The visual presenter can take a picture or a moving picture of a printed matter, a photo and the like which are necessary for explanation upon the lecture, and then display the picture or the moving picture (hereinafter, called ‘image’) through a display device.

However, the conventional visual presenter has a large volume and thus occupies a large space. Also since its price is too high to install the visual presenters in every school classroom, it is difficult for the visual presenter to be widely supplied and used. Further, in the conventional visual presenter, it is restricted in mobility due to its large volume, and there is an inconvenience in that it has to be connected with a computer or a projector through a cable.

Upon explanation of an image taken by the visual presenter, there are some occasions when it becomes necessary to mark the image or write data on the image. In this case, since a lecturer has to write the data using a computer mouse and the like, an action radius of the lecturer is considerably restricted.

Meanwhile, in the conventional art, in order for the lecturer to remotely control a multimedia computer having a built-in or connected receiving device, an ID code of a transmitting device to be used should be registered in the receiving device, and thus the receiving device can be paired and used only with the registered transmitting device. However, in this case, if the corresponding transmitting device is lost, the multimedia computer can not be used, and also other lecturers can not use the same multimedia computer using their own transmitting devices.

### DISCLOSURE OF INVENTION

### Technical Problem

An object of the present invention is to provide a remote device for transmitting a picture of a real object, which can be used by a user while being held in user's hand.

Another object of the present invention is to provide a remote device for transmitting a picture of a real object, which has a function of writing data necessary for explanation without using a computer mouse and the like.

### Technical Solution

To achieve the above objects, the present invention provides a portable remote device for transmitting a picture of a real object and written data, by which data is wirelessly transmitted to a multimedia computer, comprising a camera part; an electronic writing part; a wireless communication part for wirelessly transmitting image data obtained by the camera part or written data obtained by the electronic writing part; an input part for a user's operation and a storing part for storing driving programs of the camera part and the electronic writing part.

Preferably, the input part is a touch screen and is used as a remote controller for controlling a program, which is executed at the multimedia computer, by operating a button menu displayed on the touch screen.

Further, the present invention provides a system for transmitting a picture of a real object and written data, comprising a portable remote device for transmitting a picture of a real object and written data, by which data is wirelessly transmitted to a multimedia computer, comprising a camera part, an electronic writing part, a wireless communication part for wirelessly transmitting image data obtained by the camera part or written data obtained by the electronic writing part, an input part for a user's operation and a storing part for storing driving programs of the camera part and the electronic writing part, wherein the construction elements are incorporated into a single system so that a user can use it while holding in user's hand; a wireless communication module which receives a radio signal from the wireless communication part of the portable remote device; and a computer which is connected with the wireless communication module and displays the image data or the written data received from the portable remote device on a display part.

Further, the present invention provides a multimedia presentation method using the system, comprising (a) obtaining image data of an object through a portable remote device for transmitting a picture of a real object and written data; (b) transmitting the image data of the object to a computer and displaying the image data on a display part of the computer; (c) obtaining written data through an electronic writing part of the portable remote device; and (d) transmitting the written data to the computer and displaying the written data on the display part of the computer.

Further, the present invention provides a multimedia presentation method using the system, comprising (a) selecting a file stored in a portable remote device for transmitting a picture of a real object and written data; (b) transmitting the file to a computer; (c) storing the file in a predetermined folder and automatically executing a program for executing the file by the computer; and (d) executing the file on the program.

Further, the present invention provides a multimedia presentation method using the system, comprising (a) executing a file stored in a portable remote device for transmitting a picture of a real object and written data; (b) transmitting the file, which is executing, to the computer; (c) automatically executing a program for executing the received file by the computer; and (d) executing the file on the program.

### ADVANTAGEOUS EFFECTS

According to the present invention, since the remote device for transmitting a picture of a real object can be manufactured to have a small size and to be portable, its price can be lowered and thus it can be widely supplied and used.

Since there is no necessity for connecting the remote device for transmitting a picture of a real object and a display device with a cable, its mobility is improved and thus an action radius of a user is remarkably increased.

Therefore, the realization of a ubiquitous class (u-class) can be accelerated, and the utilization of a display device installed in a classroom and the like can be enhanced. Further, since it is possible to provide a vivid lecture by using an image of a real object, the concentration of students can be improved. Also since it is possible to easily feed back homework and the like, the learning efficiency can be increased.

Further, since it is possible to provide a vivid presentation using an image of a real object, a mistake in making a decision can be minimized and also it can be used as new means for a business talk.

Furthermore, since the potable remote device for transmitting a picture of a real object and written data according to the present invention has functions of taking and transmitting the picture of the real object and written data, and also can transmit and execute a stored file to a computer, it is possible to provide active lecture on behalf of an existing notebook computer.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram of a portable remote device for transmitting a picture of a real object and written data according to an embodiment of the present invention.

FIG. 2 is a plane view of the portable remote device for transmitting a picture of a real object and written data according to the embodiment of the present invention.

FIG. 3 is a block diagram of a system for transmitting a picture of a real object and written data according to an embodiment of the present invention.

FIGS. 4 and 5 are schematic views showing examples of a software remote controller.

FIGS. 6 and 7 are flow charts showing a method of displaying on a computer an image taken by the portable remote device for transmitting a picture of a real object and written data according to the embodiment of the present invention.

FIG. 8 is a flow chart showing a method of displaying written data on the computer.

FIG. 9 is a flow chart showing a method of automatically executing a program using a class schedule and an identification code.

### BEST MODE FOR CARRYING OUT THE INVENTION

Hereinafter, the embodiments of the present invention will be described in detail with reference to accompanying drawings.

1. Remote Device for Transmitting Picture of Real Object and Written Data

The present invention embodies a device for transmitting a picture of a real object and a writing device and provides a remote device for transmitting a picture of a real object and written data, which can transmit the photographed or written data through wireless communication to a receiving device like a computer.

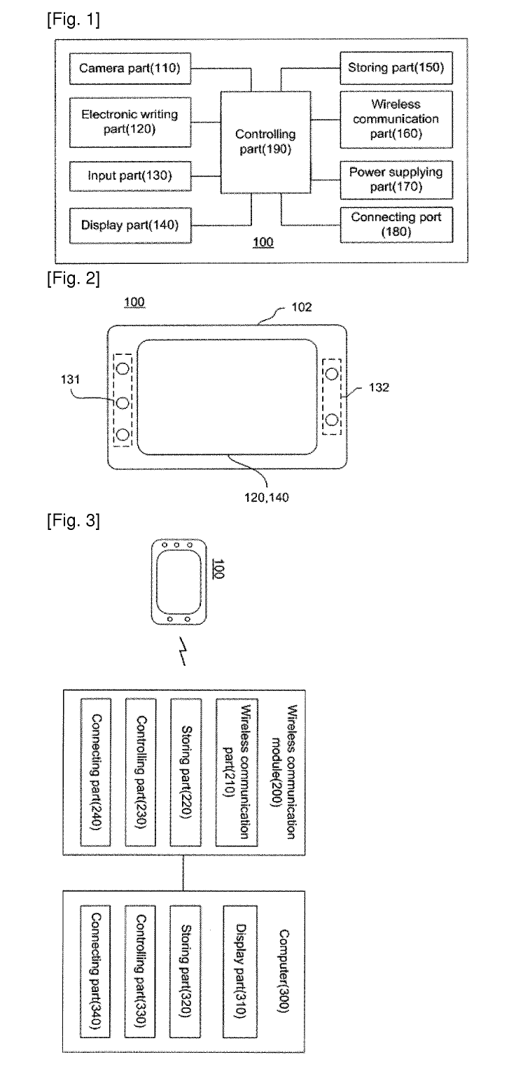

As shown in FIG. 1, a remote device 100 for transmitting a picture of a real object and written data according to an embodiment of the present invention includes a camera part 110, an electronic writing part 120, an input part 130, a display part 140, a storing part 150, a wireless communication part 160, a power supplying part 170, a connecting port 180 and a controlling part 190.

The camera part 110 includes a camera module for taking a picture of an object and a peripheral circuit for processing a taken image. A CCD (Charge coupled device) image sensor or a CMOS(Complementary Metal Oxide Semiconductor) image sensor can be used in the camera module. Preferably, the image sensor has at least 1 mega pixels or more. Meanwhile, the camera part 110 may include a flash.

The electronic writing part 120 is a means for converting a character, a picture, a diagram and the like written by a user into digital data, and includes an input pad and a peripheral circuit for recognizing and processing data input through the input pad. A well-known digitizer or a tablet may be used as the electronic writing part 120.

The input part 130 as an operating means of a user may be provided in the form of an input button or a touch screen.

In the case of the touch screen, it is preferable that the input part 130 is integrally formed with the input pad of the electronic writing part 120. In this case, although the electronic writing part 120 and the input part 130 are integrally formed with each other, they can be clearly discriminated from each other in view of their functions.

For example, the input button or input menu provided at the input part 130 includes a power button for controlling power on/off, a camera button for driving the camera part 110, a mode converting button for converting an image taking mode into a writing mode or vice versa. Further, it can include a selecting button for selecting a particular menu, and a pointer moving button for moving a pointer on the display part 140.

The input part 130 can further include a remote controlling button for remotely controlling a receiving computer.

The display part 140 functions to display a taken image so that the user can see the taken image, and an LCD panel and the like are used as the display part 140. In case that the touch screen is used as the input part 130, the LCD panel can be integrally formed with the touch screen.

However, the display part 140, the electronic writing part 120 and the input part 130 are clearly discriminated from each other in view of their functions. Since the remote device 100 for transmitting a picture of a real object and written data of the present invention is operated while being held by the user, it is preferable that the LCD panel has a small size such as 3.5 inches, 4.3 inches, but the present invention is not limited to this.

The storing part 150 functions to store photographed or written data according to the embodiment of the present invention or to store a program for processing the data, and includes RAM and ROM. If necessary, it can further include an external memory. The program stored in the storing part 150 includes, for example, a program for driving a camera, an image viewer program for arranging, editing and transmitting an image, a moving image viewer program for executing, capturing and transmitting a taken moving image, a text viewer program for editing and transmitting a captured text, a sound player for processing and outputting an effect sound or a stereo sound and so on.

The wireless communication part 160 functions to transmit to a receiving device image data taken by the camera part 110 or written data input from the electronic writing part 120, or to receive a signal from the receiving device. Various wireless communication standards such as IrDA (Infrared Data Association), Bluetooth, ZigBee, UWB (Ultra Wideband) can be applied to the wireless communication part 160. From a point of view of user's convenience, a local area communication method, such as Bluetooth and ZigBee, using RF (Radio Frequency) is more preferable than IrDA of which directivity is limited.

The power supplying part 170 functions to supply driving power to the remote device 100 for transmitting a picture of a real object and written data of the present invention, and includes a power terminal connected with an external power source, and/or a battery. Particularly, it is preferable that the power supplying part 170 has a charging circuit so as to charge a rechargeable battery using external power supplied through the power terminal.

The connecting port 180 is a means for connecting with an external device so as to transmit data or perform the charging operation, and includes a USB port and like. The USB port may be used as a connecting means connected with a computer to transmit and receive the data or as a power terminal, as described above.

The controlling part 190 functions to entirely control operations of the cameral part 110, the electronic writing part 120, the input part 130, the display part 140, the storing part 150, the wireless communication part 160 and the power supplying part 170. The controlling part 190 can be provided in the form of a one-chip microcomputer. In this case, the microcomputer may include a part or whole of the storing part 150.

Furthermore, the remote device 100 for transmitting a picture of a real object and written data of the present invention can include a laser pointer, a speaker, a microphone and the like.

As shown in the plane view of FIG. 2, since the construction elements as described above are supported in a housing 102 having a compact size, and incorporated into a single system, the remote device 100 for transmitting a picture of a real object and written data of the present invention can be used while being held in user's hand.

The electronic writing part 120, the display part 140 and the input part 130 are exposed outside of the housing 102 so that the user can operate them.

Button groups 131, 132 in FIG. 2 are an example of the input part 130. For example, a first button group 131 can be used for zooming in and zooming out a camera, displaying on the display part 140 a plurality of taken images in the form of a slide show, or moving an image displayed on the display part 140.

Further, a second button group 132 can be used for controlling power on/off, enabling and disabling functions of the camera, returning a current screen to an initial screen, or transmitting a taken image. The use of these button groups are just an example, and thus, if necessary, can be changed without any limit.

FIG. 3 is a view of a system using the remote device 100 for transmitting a picture of a real object and written data according to the embodiment of the present invention.

In the embodiment of the present invention, the remote system for transmitting a picture of a real object and written data can be embodied by connecting a wireless communication module 200 with a computer 300.

The wireless communication module 200 includes a wireless communication part 210 for transmitting and receiving a wireless signal to/from the wireless communication part 160 of the remote device 100 for transmitting a picture of a real object and written data, a storing part 220 for storing related programs, a controlling part 230 for controlling the wireless communication part 210 and the storing part 220, and a connecting part 240 for connecting with the computer 300. The storing part 220 and the controlling part 230 may be provided in the form of a single semiconductor chip.

The wireless communication module 200 can be installed in a PCI slot or a USB port of the computer 300, and further can be built-in or connected to a mother board.

The computer 300 includes a display part 310 like a monitor, a storing part 320 like

RAM and/or ROM, a controlling part 330 for controlling the display part 310 and the storing part 320, and a connecting part 340 for connecting with the wireless communication module 200.

Especially, the storing part 320 of the computer 300 stores a drive program for processing image data or written data received from the wireless communication part 210 of the wireless communication module 200 and then displaying it on the display part 310, a viewer program for displaying a received image, a graphic program and so on.

In order for the computer 300 to receive data written on the electronic writing part 120 of the remote device 100 for transmitting a picture of a real object and written data of the present invention and then displaying the data on the large-scaled display part 310, it is necessary to perform proper processes of converting the data and setting a coordinate value in the drive program of the computer 300 considering a difference in resolution.

Further, the storing part 320 of the computer 300 may store a drive program for controlling a program operation using a signal transmitted from the remote device 100 for transmitting a picture of a real object and written data of the present invention.

Like a general personal computer, the computer 300 may have a main body and a monitor (the display part) which are separated from each other. Preferably, it is a presentation specific computer in which the storing part 320 and the controlling part 330 are built in the large-scaled monitor.

As shown in the drawing, the wireless communication module 200 of the present invention can be installed separately from the computer 300, and also installed in the computer 300.

Meanwhile, the remote device 100 for transmitting a picture of a real object and written data of the present invention can be used as a remote controller for controlling an operation of program executed in the computer 300.

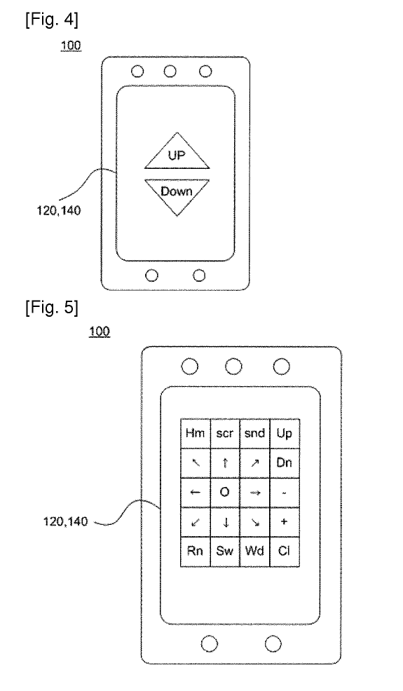

For example, the remote device 100 of the present invention can be used as a remote controller for a PowerPoint presentation by displaying a button for page up/down on a touch screen, as shown in FIG. 4, and also used as a remote controller for a storytelling presentation by providing button groups having various functions on the touch screen, as shown in FIG. 5.

2. Method of Transmitting Picture of Real Object and Written Data

Hereinafter, a method of displaying on the display part 310 of the computer 300 an image taken by the remote device 100 for transmitting a picture of a real object and written data according to the embodiment of the present invention will be described with reference to FIGS. 1, 3 and 6.

In a status that the wireless communication module 200 is connected with the computer 300 in a classroom, a power switch provided at the input part 130 of the remote device 100 for transmitting a picture of a real object and written data of the present invention is turned on (ST11).

When the switch is turned on, the remote device 100 for transmitting a picture of a real object and written data of the present invention enables the wireless communication part 160 and simultaneously attempts to pair with the wireless communication module 200 by transmitting a predetermined signal. A detailed pairing method will be described later (ST12).

In a status that the pairing is completed, if a camera button provided at the input part 130 is pushed, the camera part 110 is activated, and an image recognized in the camera part 110 is displayed through the display part 140 under the control of the controlling part 190 (ST13, ST14).

Then, if a user takes off his/her hand from the camera button, the image displayed on the display part 140 is captured, and a data file of the captured image is stored in the storing part 150 (ST15, ST16).

And the wireless communication part 160 transmits the data file stored in the storing part 150 to the wireless communication module 200 connected to the computer 300 under the control of the controlling part 190 (ST17).

The wireless communication module 200 transmits the received data file to the computer 300, and the transmitted data file is stored in a predetermined folder of the computer 300 (ST18, ST19).

The controlling part 330 of the computer 300 determines whether an exclusive program for displaying the received image data is activated (ST20), and displays the data file in a corresponding program, if the exclusive program is activated. Of course, the image is displayed through the display part 310 (ST21).

In the ST20, if the exclusive program is not executed, the controlling part 330 executes the corresponding program and then displays the data file in the corresponding program (ST22, ST21).

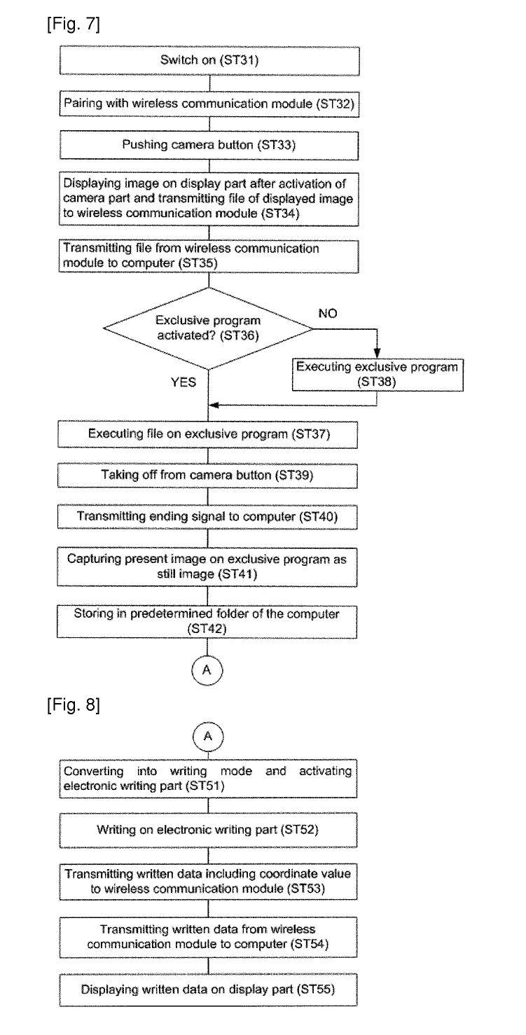

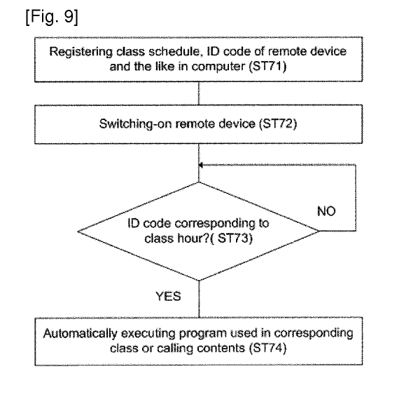

Hereinafter, a method of displaying on the display part 310 of the computer 300 an image taken by the remote device 100 for transmitting a picture of a real object and written data according to other embodiment of the present invention will be described with reference to FIG. 7.

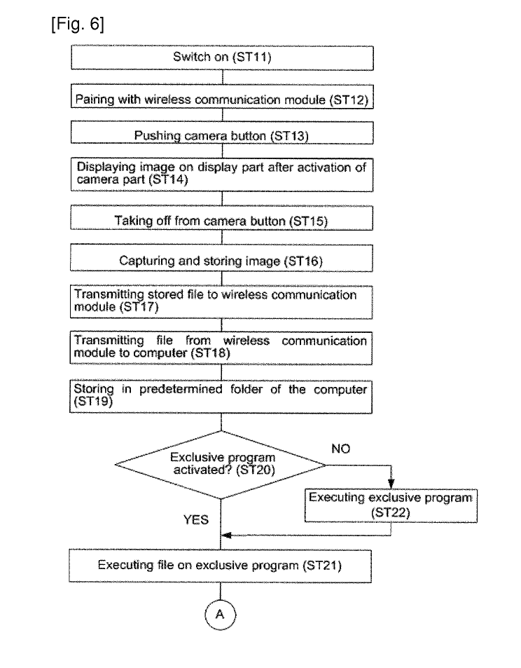

Since ST31 to ST33 in FIG. 7 are the same as the ST11 to ST13 in FIG. 6, the description thereof will be omitted.

After pairing operation is completed, if a user pushes a camera button, the camera part 110 is activated by the controlling part 190. An image recognized in the camera part 110 is displayed through the display part 140, and a data file of the displayed image is transmitted to the wireless communication module 200 connected to the computer 300 in real-time (ST34).

The wireless communication module 200 transmits the received data file to the computer 300 (ST35).

The controlling part 330 of the computer 300 determines whether an exclusive program for displaying the received image data is activated (ST36), and displays the data file in a corresponding program, if the exclusive program is activated. Of course, the image is displayed through the display part 310 (ST37).

In the ST36, if the exclusive program is not executed, the controlling part 330 executes the corresponding program and then displays the data file in the corresponding program (ST38, ST37).

To this time, the user continuously should push the camera button of the remote device 100 for transmitting a picture of a real object and written data. If the user takes off his/her hand from the camera button, a predetermined ending signal is transmitted to the computer 300 (ST39, ST40).

After receiving the ending signal, the computer 300 captures the displayed image as a still image and then stores the captured image in a predetermined folder (ST41, ST42).

In order to mark or write data on the captured image while the captured image is displayed on the display part 310 of the computer 300, the user converts a mode of the remote device 100 for transmitting a picture of a real object and written data into a writing mode so as to activate the electronic writing part 120. The mode converting operation can be performed in various methods.

For example, as the simplest method, in ST15 of FIG. 6 and ST39 of FIG. 7, the mode converting operation can beset so that the camera mode is automatically converted into the writing mode at the moment when the user takes off his/her hand from the camera button of the remote device 100. In other words, it is convenient that, when the user pushes the camera button, the remote device 100 is in the camera mode, and when the user takes off his/her hand from the camera button, the remote device 100 is in the writing mode.

As other method, a mode converting button is provided at the input part 130 of the remote device 100, and the mode converting operation can be set to be converted from the camera mode to the writing mode or from the writing mode to the camera mode when the user pushes the mode converting button (ST51).

After the remote device 100 is converted from the camera mode to the writing mode, if the user writes data on the electronic writing part 120, written data including a coordinate value is generated and then transmitted through the wireless communication part 160 to the wireless communication module 200 connected to the computer 300 (ST52, ST53).

The wireless communication module 200 transmits the received written data to the computer 300, and the computer 300 displays the written data on the display part 310. At this time, since the captured image is already displayed on the display part 310, the written data is overlapped and displayed on the image (ST54, ST55).

Meanwhile, a text viewer program can be installed in the remote device 100 for transmitting a picture of a real object and written data of the present invention so as to transmit a text to the computer 300. At this time, if the computer 300 automatically executes a word program and displays text data, it may be impossible to perform the writing operation.

Therefore, it is preferable that, if the computer 300 receives the text data, the computer 300 converts the text data into an image file and displays it in a graphic mode so that the user can write data on the screen of the computer 300 using the remote device 100.

Until now, the method of transmitting to the computer and displaying on the display part 310 of the computer 300 an image or written data photographed by the remote device 100 for transmitting a picture of a real object and written data according to the present invention was described.

This method can be also applied to other process in which a portable electronic device including a wireless communication means, a storing means, an input means, a display means, a controlling means and the like transmits to and displays a stored file on a multimedia computer connected with a large-scaled monitor or screen.

For example, this method can be set so that, if a user selects a file stored in the portable electronic device and then pushes a transmitting button, a process of transmitting the corresponding file through the wireless communication means to the multimedia computer, a process of storing the received file in a particular folder of the multimedia computer, a process of automatically executing a program for executing the received file and a process of executing the received file on the program in the multimedia computer are sequentially performed.

As other method, this method can be set so that, if a user executes a file stored in the portable electronic device and then pushes a transmitting button, a process of transmitting data, such as a text, an image and a sound, to the multimedia computer, a process of automatically executing a program for executing the data in the multimedia computer, a process of reorganizing the received data according to organization of the multimedia computer and a process of executing the reorganized data on the program are sequentially performed.

Due to these methods, since the user can transmit a prepared file to the computer and then execute it by one touch operation, it is possible to reduce user's unnecessary effort and also to considerably increase the concentration in study.

3. Pairing Method

Meanwhile, if every lecturer has the remote device 100 for transmitting a picture of a real object and written data of the present invention in each classroom, the wireless communication module 200 installed in each classroom may receive and process a signal of the remote device 100 which is operating in a next classroom.

In order to prevent such interference, it is preferable that the remote device 100 is paired with the wireless communication module 200 which is installed in a corresponding classroom before using it. Particularly, in case of using RF communication other than IrDA communication having directivity, the need for prevention of the interference is further increased. A signal processing operation for the pairing can be performed directly in the wireless communication module 200, or in the computer 300 which receives a signal of the wireless communication module 200. However, for convenience of explanation, the signal processing operation is performed in the wireless communication module 200, as will be described below.

Short Range Pairing Method and Power Controlling Method of Multimedia Computer

In this method, only when the remote device 100 for transmitting a picture of a real image and written data comes close to the wireless communication module 200 or the computer 300, they can be paired with each other. And it is not necessary to previously register an identification code of the remote device 100 in the wireless communication module 200 or the computer 300. This can be realized in various methods.

As a first method, a pairing signal of the remote device 100 is allowed to have only a short effective range of about 2 meters so that the pairing signal can not reach the wireless communication module 200 in the next classroom.

Alternatively, the wireless communication module 200 transmits a pairing induction signal having a short effective range of about 2 meters and recognizes an identification code of the remote device 100 which is located within the effective range. The effective range of the induction signal can be controlled by adjusting signal strength.

The pairing signal used in this method may be a RF signal or an optical signal (e.g., an infrared signal) having straight advancing property. The pairing signal includes the identification code assigned to the remote device 100, and the identification code may be a proper number like ESN (Electronic Serial Number) of a cellular phone, or may be set by the user.

The wireless communication module 200 temporarily stores the identification code included in the received pairing signal, and selects and processes only a signal transmitted from the remote device 100 corresponding to the stored identification code.

In this case, the remote device 100 can be provided with a separate pairing button for the sake of user's convenience. And if the pairing button is pushed, a predetermined pairing signal is transmitted, or if a power switch of the remote device 100 is turned on, the predetermined pairing signal is automatically transmitted.

As a second method, a RFID card is provided at the remote device 100, and a RF reader is provided at the wireless communication module 200 so as to receive a signal from the RFID card or obtain information from the RFID card. The RFID card stores the identification code and also can transmit a pairing signal including the identification code. The RFID card includes a RFID chip and an antenna.

A magnetic tape storing the identification code may be provided instead of the RFID card, and a recognizing means for recognizing the identification code stored in the magnetic tape is provided at the wireless communication module 200.

In case of using the RFID card or the magnetic tape, since the pairing operation is performed only when the remote device 100 is contacted with or approached to the wireless communication module 200, there is no fear that the pairing signal reaches the wireless communication module 200 in the next classroom.

In this case, the wireless communication module 200 temporarily stores the identification code included in the pairing signal obtained from the RFID card or the magnetic tape, and selects and processes only a signal transmitted from the remote device 100 corresponding to the stored identification code.

The RFID card and the magnetic tape are to receive the identification code of the remote device 100 in a status that the remote device 100 is approached to the wireless communication module 200. Therefore, they can be substituted with other communication means of a similar type.

If a signal is not transmitted from the remote device 100 within a predetermined time interval (e.g., 1 hour) or the computer 300 is turned off, the identification code of the remote device 100, which is temporarily registered in the wireless communication module 200 by the short range pairing operation, can be deleted, or be in the disable state until a separate control signal is received.

In a status that a first remote device is temporarily registered by the short range pairing operation, a second remote device may attempt the short range pairing operation. In this case, the wireless communication module 200 may change the identification code of the first remote device into the identification code of the second and process only the signal of the second remote device, or may additionally and temporarily register the identification code of the second remote device and equally process the signals of the first and second remote devices, or may additionally and temporarily register the identification code of the second remote device under permission from the user of the first remote device and process the signal of the second remote device.

The permission from the first remote device can be issued by that the wireless communication module 200 or the computer 300 transmits to the first remote device a signal asking whether the user of the first remote device permits the use of the second remote device and the user of the first remote device transmits a signal permitting the user of the second remote device in a desired manner.

The short range pairing method can be used to control the power of the computer 300. In other words, if a predetermined button of the remote device 100 is pushed, a power controlling signal is transmitted in the form of an optical signal having the straight advancing property or a RF signal having the limited effective range, whereby it is possible to control only the power of the computer in a corresponding classroom without any effect on other computer in a next classroom.

In addition, it is possible to control only the computer in the corresponding classroom by allowing the RFID card or the magnetic tape provided at the remote device 100 to be recognized by the recognizing means of the computer 300.

Non-Registered Pairing Method

In this method, the pairing operation is performed in a status that an identification code of the remote device 100 is not previously registered in the wireless communication module 200 or the computer 300 or in a status that an identification code of the remote device 100 is previously registered in the wireless communication module 200 or the computer 300.

In the former, i.e., a non-registered pairing method, if the remote device 100 is switched on and transmits a predetermined pairing signal in the form of a RF type, the wireless communication module 200 receives the pairing signal and temporarily registers the identification code included in the pairing signal, and then processes only a signal corresponding to the registered identification code.

This method allows only one remote device to be temporarily registered, and the registered identification code is stored only until a next user performs the pairing operation or the computer is turned off.

It is also possible to temporarily allow a plurality of remote devices in the non-registered pairing method. For example, in a status that a first remote device is paired without registration, if a pairing signal is received from a second remote device, an identification code of the second remote device is additionally and temporarily registered and the signals from the first and second remote devices are equally processed.

Alternatively, the first remote device that is formerly registered may be set as a main remote device and the second remote device that is lately registered is set as a subsidiary remote device. In this case, only when the user of the first remote device permits the use of the second remote device, the wireless communication module 200 or the computer 300 processes the signal of the second remote device.

As an example of the temporary registration, one or more pairing lists are set in the wireless communication module 200 or the computer 300 so as to register the identification codes of one or more remote devices 100, and then the identification code of the remote device 100 requesting the pairing is temporarily registered in the pairing list.

In this case, the wireless communication module 200 or the computer 300 processes only the signal from the remote device 100 registered in the pairing list, and the identification code of the corresponding remote device 100 is deleted from the pairing list when the pairing is canceled. A condition of pairing cancelation may include a case that the computer 300 is turn off, a case that a predetermined pairing cancelation signal is received from the remote device 100, a case that any signal is not received during a predetermined time interval and so forth.

Registered Pairing Method

In this method, the pairing operation is performed in a status that the identification codes of one or more remote devices 100 to be used are previously registered in a registration list of the wireless communication module 200 or the computer 300.

If the registered remote device 100 is used, the wireless communication module 200 or the computer 300 determines whether a received signal includes the identification code of the registered remote device and then processes only a signal including the identification code of the registered remote device. At this time, there are an existing method which has only a single registration list so that only one registered remote device can be permanently used and other method which allows a plurality of remote devices of the same type to be registered and used by a plurality of users.

In case that a plurality of identification codes are registered in the wireless communication module 200 or the computer 300, other lecturers at each class hour can perform the pairing operation and then use the computer 300.

Further, in case that two or more lecturers participate in class, or there is necessity for feedback between a lecturer and students, or in case of a conference having many participants, two or more remote devices 100 may be used.

In this case, the wireless communication module 200 or the computer 300 activates the pairing with the first and second remote devices at the same time and equally processes the signal from the first and second remote devices. Alternatively, the wireless communication module 200 or the computer 300 activates the first remote device that is formerly connected and sets the first remote device as a main remote device, and also activates the second remote device and sets as a subsidiary remote device only when the user of the first remote device permits the use of the second remote device and then processes the signal of the second remote device. Furthermore, if the main remote device performs the pairing operation in a status that the subsidiary remote device is paired, the pairing of the subsidiary remote device may be canceled and then the pairing of the main remote device may be achieved.

It is also possible to allow a third non-registered remote device to be permitted and used. To this end, since the pairing of the third remote device should be achieved, an identification code included in a signal of the third remote device is allowed to be extracted and then temporarily registered in the wireless communication module 200 or the computer 300.

The temporary registration means that the wireless communication module 200 or the computer 300 is set to be in an inactivated state until a separate control signal is received, or to delete a registered identification code of the remote device 100 in case that a signal of the remote device 100 is not received within a predetermined time interval (e.g., 1 hour), in case that the computer 300 is turned off, or in case that other remote device 100 is transmits pairing signal.

Meanwhile, the wireless communication module 200 or the computer 300 can be additionally provided with the pairing list besides the registration list.

In this case, firstly, it is determined whether an identification code of a remote device 100 requesting the pairing is registered in the registration list. If the identification code is registered in the registration list, the identification code of the corresponding remote device is recorded in the pairing list, and the pairing with the corresponding remote device is activated. And when the pairing is canceled, only the identification code of the corresponding remote device 100 recorded in the pairing list is deleted, thereby inactivating the pairing.

Pairing Method Interlocked with Class Schedule

Since most educational institutions have their own class schedules by terms, it is necessary to automate a multimedia class in each class room so as to make a more effective lesson.

If information on the multimedia class using computer 300 installed in a classroom, an identification code of a remote device 100 to be used in the corresponding multimedia class and the like is previously stored in the computer 300 in each class room and interlocked with the class schedule, it is possible to reduce preparing time for class and improve a lecturer's convenience.

As shown in the flow chart of FIG. 7, the information on a class schedule, an identification code of the remote device 100 and the like is previously stored in the computer 300 in each class room (ST71). In this situation, a lecturer switches on the remote device 100 (ST72). At this time, the computer 300 determines whether an identification code included in a signal from the remote device 100 is identical with an identification code corresponding to the present class (ST73). If the identification code is identified, the pairing is achieved. Then, the computer 300 automatically executes a multimedia program necessary for the corresponding class and displays it on a main screen, or displays a menu of the multimedia programs on the display part 310. Further, the computer 300 may retrieves necessary contents and then displays on the display part 310 (ST74).

Therefore, since the lecturer does not need to execute the necessary multimedia program or operate the computer 300 to retrieve the contents, the lecturer and students can rapidly concentrate on class.

Furthermore, since the computer 300 is paired with the remote device 100 having an identification code corresponding to class, there is no fear of interference with other remote device in a next classroom.

If the class hour or the lecturer is changed, it is necessary to change the class schedule and the identification code of the remote device stored in the computer 300. Preferably, this changing operation is performed at a central server connected with the computer 300 in each classroom.

Until now, the pairing method of the remote device 100 of the present invention and the presentation method interlocked with the class schedule have been described. These methods can be applied to a case that a portable electronic device provided with a wireless communication means, a storing means, an input means, a display means, a controlling means and the like is paired with a multimedia computer connected to a large-scaled monitor or screen and a case of presentation using the same.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1-15. (canceled)

16. A presentation method using a remote data transmission system including a hand-held remote device and a computer having a display device, wherein the hand-held remote device includes a camera having a camera button, a wireless communication device for transmitting data, and a storing device having one or more operating programs, the presentation method comprising:
obtaining still image data of an object with the camera when the camera button is pressed;
transmitting the still image data to the computer through the wireless communication device; and
displaying the still image on the display device of the computer if a processing program has been activated for the still image data, otherwise activating the processing program and then displaying the still image of the object on the display device of the computer.

17. The presentation method of the claim 16, further comprising storing the still image data of the object in a predetermined folder of the computer.

18. A presentation method using a remote data transmission system including a hand-held remote device and a computer having a display device, wherein the hand-held remote device includes a camera having a camera button, an electronic writing device, a wireless communication device for transmitting data, and a storing device having one or more operating programs, the presentation method comprising:
obtaining still image data of an object with the camera when the camera button is pressed;
transmitting the still image data to the computer through the wireless communication device;
displaying a still image of the object on the display device of the computer if a processing program has been activated for the still image data, otherwise activating the processing program and then displaying the still image of the object on the display device of the computer;
transmitting writing data obtained by the electronic writing device to the computer through the wireless communication device; and
displaying the writing data over the still image of the object displayed on the display device of the computer.

19. The presentation method of claim 18, wherein the one or more operating programs of the hand-held remote device changes a camera mode for obtaining the image data to a writing mode for obtaining the writing data when pressing of the camera button is discontinued.

20. A presentation method using a remote data transmission system including a hand-held remote device and a computer having a display device, wherein the hand-held remote device includes a camera having a camera button, a wireless communication device for transmitting data, and a storing device having one or more operating programs, the presentation method comprising:
transmitting image data of an object in real-time from the hand-held remote device to the computer through the wireless communication device when the camera button is pressed;
displaying an image of the object in real-time on the display device of the computer if a processing program has been activated for the still image data, otherwise activating the processing program and then displaying the image of the object in real-time on the display device of the computer;
obtaining a still image from the image displayed on the display device of the computer, upon receiving a signal transmitted from the hand-held remote device wherein the signal is transmitted when pressing of the camera button is discontinued; and
displaying the still image on the display device of the computer.

21. The presentation method of the claim 20, further comprising storing the still image data of the object in a predetermined folder of the computer.

22. A presentation method using a remote data transmission system including a hand-held remote device and a computer having a display device, wherein the hand-held remote device includes a camera having a camera button, an electronic writing device, a wireless communication device for transmitting data, and a storing device having one or more operating programs, the presentation method comprising:
transmitting image data of an object in real-time from the hand-held remote device to the computer through the wireless communication device when the camera button is pressed;
displaying an image of the object in real-time on the display device of the computer if a processing program has been activated for the still image data, otherwise activating the processing program and then displaying the image of the object in real-time on the display device of the computer;
obtaining a still image from the image displayed on the display device of the computer, upon receiving a signal transmitted from the hand-held remote device wherein the signal is transmitted when pressing of the camera button is discontinued;
displaying the still image on the display device of the computer;
transmitting writing data obtained by the electronic writing device to the computer through the wireless communication device; and
displaying the writing data over the still image of the object displayed on the display device of the computer.

23. The presentation method of claim 22, wherein the one or more operating programs of the hand-held remote device changes a camera mode for obtaining the image data to a writing mode for obtaining the writing data when pressing of the camera button is discontinued.

24. A presentation method using a remote data transmission system including a hand-held remote device and a computer having a display device, wherein the hand-held remote device includes a camera having a camera button, a wireless communication device for transmitting data, and a storing device having one or more operating programs, the presentation method comprising:
changing an operating mode of the hand-held remote device to a camera mode allowing the camera to obtain image data of an object when the camera button is pressed;
displaying an image of the object on a display device of the hand-held remote device in real-time;
obtaining still image data, when pressing of the camera button is discontinued, from the displayed image of the object by the hand-held remote device;
transmitting the still image data to the computer; and
displaying the still image of the object on the display of the computer if a processing program has been activated for the image data, otherwise activating the processing program and then displaying the still image of the object on the display device of the computer.

25. The presentation method of the claim 24, further comprising storing the still image data of the object in a predetermined folder of the computer.

26. A presentation method using a remote data transmission system including a hand-held remote device and a computer having a display device, wherein the hand-held remote device includes a camera having a camera button, an electronic writing device, a wireless communication device for transmitting data, and a storing device having one or more operating programs, the presentation method comprising:
changing an operating mode of the hand-held remote device to a camera mode allowing the camera to obtain image data of an object by pressing the camera button;
displaying an image of the object on a display device of the hand-held remote device in real-time;
obtaining still image data, when pressing of the camera button is discontinued, from the image of the object by the hand-held remote device and transmitting the still image data to the computer through the wireless communication device;
displaying the still image of the object on the display of the computer if a processing program has been activated for the still image data, otherwise activating the processing program and then displaying the still image of the object on the display device of the computer;
transmitting writing data obtained by the electronic writing device to the computer through the wireless communication device; and
displaying the writing data over the still image of the object displayed on the display device of the computer.

27. The presentation method of claim 26, wherein the one or more operating programs of the hand-held remote device changes a camera mode for obtaining the image data to a writing mode for obtaining the writing data when pressing of the camera button is discontinued.

28. A remote data transmission system comprising:
a hand-held remote device including a camera, a camera button, a wireless communication device for transmitting data obtained by the camera, and a storing device having one or more operating programs; and
a computer including a display device,
wherein the hand-held remote device obtains image data of an object and automatically transmits the image data to the computer when the camera button is pressed, and
wherein the computer receives the image data from the hand-held remote device and displays the image data on the display device upon receipt of the image data.

29. The remote data transmission system of claim 28, wherein the computer includes a program to activate a processing program for the image data when the processing program is turned off.

30. The remote data transmission system of claim 28, wherein:
the hand-held remote device further comprises an electronic writing device;
the hand-held remote device transmits writing data to the computer upon obtaining the writing data through the electronic writing device; and
the computer displays the writing data over the image of the object displayed on the display device.
